(19) United States
(12) Patent Application Publication
(10) Pub. No.: US 2013/0006879 A1
(43) Pub. Date: Jan. 3, 2013

(54) Guiding Interactions Between Users of Social Networking Services Based on Business Relationships

(75) Inventors: Rajesh Ramanathan, Redmond, WA (US); Hubert Van Hoof, Seattle, WA (US)

(73) Assignee: MICROSOFT CORPORATION, Redmond, WA (US)

(21) Appl. No.: 13/171,287

(22) Filed: Jun. 28, 2011

(51) Int. Cl. G06Q 99/00

(52) U.S. Cl. 705/319

(57) ABSTRACT

A computing device collects data from one or more data sources. The data sources are separate from a social networking service. The computing device uses the data from the data sources to generate group membership suggestions for members of a given user's social network. Because the computing device suggests the group memberships, the given user may be more likely to assign members of the given user's social network to groups. When the given user shares posts on the social networking service, the given user can limit access to the posts to members of selected groups.

### BACKGROUND

Social networking services such as Facebook®, LinkedIn®, and Twitter® have become a fast and convenient way to share information and content with others in a user's social network. Often a user will add both personal contacts (e.g., friends and family) and business contacts (e.g., bosses, clients, or coworkers) to his/her social network. For many social networking services, the expediency of adding contacts to a user's social network often requires nothing more than sending or accepting an invitation to connect with another user. Once connected, the contact is generally added to the global social network of the user. Some social networking services enable users to selectively assign related contacts to groups. These groups generally serve as distribution lists and/or the basis for controlling access to selected information and content shared by the user.

While adding contacts to the user's social network is generally designed to be quick and routine, creating and maintaining appropriate groups is an optional and extra step requiring intentional effort on the part of the social networking service user. As a result, the lines between personal and business contacts and between subdivisions within those groups become blurred or are non-existent. Moreover, the appropriate grouping of a contact may change over time, requiring the user to periodically review the groups and make any necessary changes. Even if the user does group the contacts, there may be considerable delay between the time the contact is added and the time contact is grouped. During such delay period, the new contact may have access to or receive content that may be inappropriate for the new contact or the new contact may be restricted from accessing and omitted from distribution of content that should be available to the new contact.

Designating particular people as belonging to particular groups can be a time consuming process. A user may have to go through the people in his/her social network one-by-one and indicate the groups to which the people belong. Because of the time consuming nature of this process, many users fail to designate the groups to which the people in their social networks belong. As a result, a given member of a user's social network may have access to a post even though the user may prefer the given member not have access to the post.

Furthermore, at the time when a user wants to share a post, the user may need to manually select which groups have access to the post in order to control which people have access the post. Users can find this extra step inconvenient and neglect to designate which groups can access the users' posts. As a result, a given member of a user's social network may have access to a post even though the user may prefer the given member not have access to the post.

### SUMMARY

A computing device retrieves data from one or more data sources. The data sources are separate from a social networking service. The computing device uses the data from the data sources to suggest group memberships for members of a given user's social network. Because the computing device suggests the group memberships, the given user may be more likely to assign members of the given user's social network to groups.

In some embodiments, at a time that the given user attempts to share a post on the social networking service, a computing device uses data from the one or more data sources to suggest potentially inappropriate groups for the post. The potentially inappropriate groups for the post include people with whom it may be inappropriate to share the post. Because the computing device suggests the potentially inappropriate groups for the post, the given user may be more likely to designate which groups have access to the post.

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a block diagram illustrating an example system in which a user accesses a social networking service.

FIG. 2 is a block diagram illustrating example details of the system.

FIG. 3 is a block diagram illustrating example alternate details of the system.

FIG. 4 is a flowchart illustrating an example operation performed by the client application when the user receives a connection request from another user of the social networking service.

FIG. 5 is a screen illustration showing an example connection request interface.

FIG. 6 is a flowchart illustrating an example operation performed by the client application when the user adds another user to the user's social network.

FIG. 7 is a screen illustration showing an example group assignment interface.

FIG. 8 is a flowchart illustrating an example operation of a linking system.

FIG. 9 is a flowchart illustrating an example operation performed by the client application to share a post on the social networking service.

FIG. 10 is a screen illustration of an example access control interface.

FIG. 11 is a flowchart illustrating an example operation performed by a posting system.

FIG. 12 is a flowchart illustrating an example operation of a link suggestion system.

FIG. 13 is a diagram illustrating an example grouping of users in a social network of a user.

FIG. 14 is a diagram illustrating another example grouping of the users in the social network of the user.

FIG. 15 is a block diagram illustrating an example computing device.

### DETAILED DESCRIPTION

Embodiments use data from data sources separate from a social networking service to help users control access to posts on the social networking service. The following detailed description and the attached figures illustrate example embodiments. The reader will understand that other embodiments exist and are within the scope of the attached claims. In the attached figures, ellipses between items represent one or more similar, but not necessarily identical, items. Items having the same reference numbers with different alphabetical suffixes (e.g., “A” through “N”) are not intended to indicate the existence of a specific number of items.

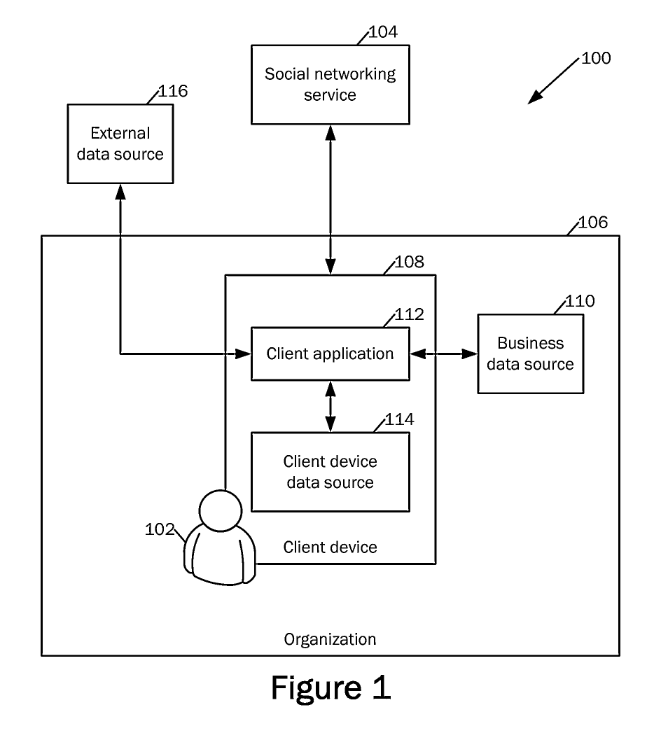

FIG. 1 is a block diagram illustrating an example system 100 in which a user 102 associated with an organization 106 accesses a social networking service 104 via a client device 108. The system 100 also includes one or more data sources. At least one of the data sources is a business data source associated with the organization 106 and not associated with the social networking service 104. The business data source 110 is a data source that contains information about people, groups, and/or entities associated with the organization or enterprise. Examples of suitable business data sources include directory services, such as Active Directory®, and non-public enterprise social networking services, such as SharePoint® My Site, from Microsoft Corporation. The illustrated embodiment of the system 100 shows additional optional data sources that may be used in addition to the business data source 110. Such optional data sources include a client device data source 114 that provides information specific to the data source, such as location, and an external data source 116 that is not affiliated with either the organization or the social networking service, such as an alternate social networking site or public available data. Readers will understand that other embodiments include other people and systems.

The user 102 is a person associated with the organization 106. In various embodiments, the organization 106 belongs to various types of organizations. For example, the organization 106 can be a business organization, such as a corporation, company, partnership, and so on. In another example, the organization 106 can be a governmental organization, a non-profit organization, a non-governmental organization, a foundation, or another type of organization.

In various embodiments, the user 102 is associated with the organization 106 in various ways. For example, the user 102 can be an employee of the organization 106, a contractor for the organization 106, a board member of the organization 106, a user of services provided by the organization 106, a constituent of the organization 106, or have another relationship with the organization 106.

The user 102 uses the client device 108. In various embodiments, the client device 108 can comprise various types of computing devices. For example, the client device 108 can comprise a personal computer, a smartphone, a laptop computer, a tablet computer, a netbook computer, a television set-top box, an in-car computer, a networked appliance, a thin-client device, a server computer, or another type of computing device.

The social networking service 104 provides an online service, platform, or site that focuses on building and reflecting social networks or social relations among people. Example social networking services include Facebook®, Twitter®, MySpace, LinkedIn®, Orkut®, Bebo®, Hi5, Friendster®, renren, Mixi, and so on.

The user 102 has a profile on the social networking service 104. The profile stores information that identifies people in the social network of the user 102. Various social networking services use various terms to refer to people who are in the social network of a given user. For example, in the terminology of Facebook®, people in the social network of a given user are referred to as the “friends” of the given user. In another example, in the terminology of Twitter, people in the social network of a given user are referred to as “followers” of the given user. In yet another example, in the parlance of LinkedIn, people in the social network of a given user are referred to as the “connections” of the given user. For ease of explanation, this document can refer to people in the social network of the user 102 as members of the user's social network.

A client application 112 runs on the client device 108. The client application 112 presents user interfaces to the user 102 and receives input from the user 102 through the user interfaces. The user 102 uses the user interfaces to interact with the social networking service 104. In various embodiments, the client application 112 comprises various types of applications. For example, the client application 112 can be a web browser application, such as INTERNET EXPLORER® from Microsoft Corporation, FIREFOX® from the Mozilla Foundation, CHROME® from Google, Inc., and so on. In another example, the client application 112 can be a special-purpose client application, such as WINDOWS LIVE MESSENGER® from Microsoft Corporation In yet another example, the client application 112 can be a smartphone or tablet computer “app,” such as the FACEBOOK® app, the LINKEDIN® app, or the WINDOWS LIVE MESSENGER® app from Microsoft Corporation.

The user 102 uses the client application 112 to access the social networking service 104. When accessing the social networking service 104, the user 102 can perform various activities. For example, the user 102 can access the social networking service 104 to establish social networking links with other users of the social networking service 104. In other words, the user 102 can, in the terminology of Facebook®, “friend” other people.

In another example, the user 102 can access the social networking service 104 to share posts on the social networking service 104. In various embodiments, posts can comprise various types of data shared with one or more other users of the social networking service 104. For example, a post can be a status update, a wall post, a “like,” a tweet, a link to a website, a digital image, a video, or another type of data shared with one or more other users of the social networking service 104.

Different members of the user's social network have different relationships with the user 102. For example, some members of the user's social network can be co-workers, friends, family members, supervisors, subordinates, clients, classmates, spouses, or have other relationships with the user 102.

Because different members of the user's social network have different relationships with the user 102, the user 102 may not want to share a given post with all members of the user's social network. For example, the user's social network can include the user's boss. In this example, the user 102 may not want to share pictures of the user's birthday party with the user's boss, but may want to share these pictures with the user's friends. In another example, the user 102 may want to share private information with the user's co-workers at the organization 106 but not with people outside the organization 106.

The social networking service 104 enables the user 102 to create groups and to designate members of the user's social network as belonging to the groups. For example, the user 102 can create a “classmates” group and a “co-workers” group. In this example, the user 102 can designate a given person as belonging to the “classmates” group and can designate another person as belonging to the “co-workers” group. For ease of explanation, this document can refer to the groups created by the user 102 as the user's groups.

When the user 102 shares a post on the social networking service 104, the user 102 can choose to limit access to the post to the members of particular groups. For example, the user 102 can choose to limit access to pictures of the user's birthday party to members of a “friends” group.

Each of the user's groups is a subset of the members of the user's social network. For instance, the user's social network can include users A, B, C, D, E, and F. In this example, a first group can include users A, B, and C, a second group can include user E, a third group can include users C, D, E, and F, and so on. A give user can belong to multiple ones of the user's groups.

When the user 102 establishes a social networking link with another person, the client application 112 presents a group assignment interface. The group assignment interface prompts the user 102 to assign the other person to one or more groups. Furthermore, the group assignment interface can include information that suggests one or more groups to which the other person may belong. For example, the group assignment interface can include information that indicates that the other user may belong to a “co-workers” group. Because the group assignment interface includes information that suggests groups to which the other person may belong, the user 102 may be less likely to skip the step of designating the groups to which the other user belongs. In other words, the user 102 may be more likely to assign the other person to one or more groups.

Furthermore, the client application 112 presents a posting interface to the user 102. The user 102 uses the posting interface to input and submit a post to the social networking service 104. Prior to the post being shared on the social networking service 104, the client application 112 presents an access control interface to the user 102. The access control interface prompts the user 102 to designate which groups are allowed to access the post. Furthermore, the access control interface includes information that indicates one or more groups with whom it might be appropriate or inappropriate to share the post. For example, the access control interface may include information that indicates that the post may be appropriate to share with members of a “friends” group and members of a “family” group, but not appropriate to share with members of a “co-workers” group. After the user 102 selects which groups have access to the post, the post is shared on the social networking service 104 such that only members of the selected groups have access to the post. Because the access control interface indicates potentially appropriate or inappropriate groups, the user 102 may be less likely to skip the step of designating with groups have access to the post.

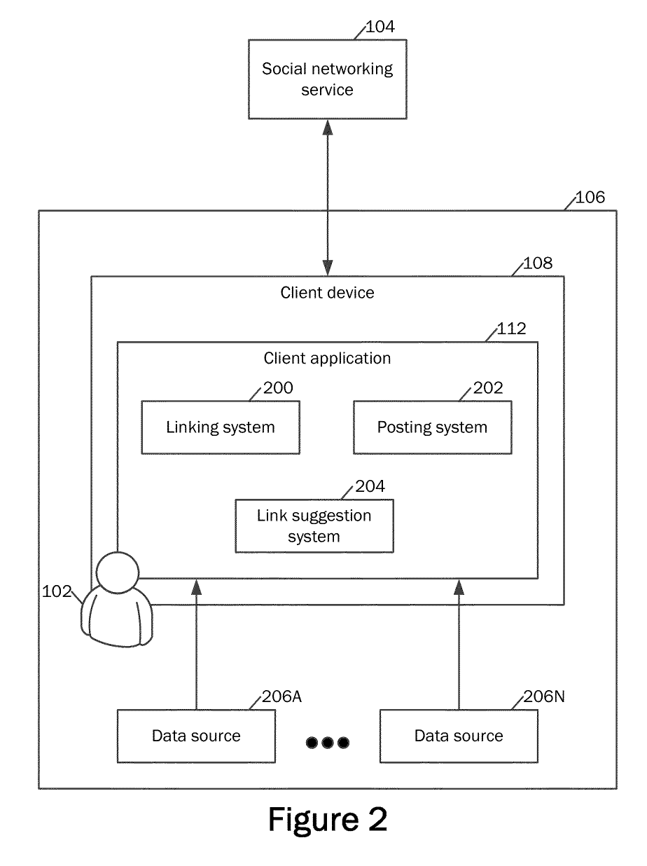

FIG. 2 is a block diagram illustrating example details of the system 100. As illustrated in the example of FIG. 2, the client device 108 provides the client application 112. In various embodiments, the client device 108 provides the client application 112 in various ways. For example, some embodiments of the client device 108 include one or more processing units. In this example, the one or more processing units of the client device 108 read computer-executable instructions from one or more computer readable media and execute the computer-executable instructions. Execution of the computer-executable instructions causes the client device 108 to provide the client application 112.

In the example of FIG. 2, the client device 108 provides a linking system 200, a posting system 202, and a link suggestion system 204. Some embodiments of the client application 112 do not provide all of these systems. Furthermore, some embodiments of the client application 112 provide systems in addition to or other than the linking system 200, the posting system 202, and the link suggestion system 204.

The client application 112 collects data from one or more data sources 206A-206N (collectively, “data sources 206”). The data sources 206 are separate from the social networking service 104. For example, the social networking service 104 may be unable to retrieve data from the data sources 206. Furthermore, in some embodiments, only computing devices associated with users who belong to the organization 106 can retrieve data from the data sources 206.

When the user 102 adds another person to the user's social network, the linking system 200 uses data from one or more of the data sources 206 to suggest groups to which the other person may belong. When the user 102 submits a post to the social networking service 104, the posting system 202 uses data from one or more of the data sources 206 to suggest groups with which it may be appropriate or inappropriate to share the post. The link suggestion system 204 uses data from one or more of the data sources 206 to suggest other users of social networking service 104 as potential members of the user's social network.

The data source 206 is implemented in various ways. For example, one embodiment of the business data source 206 uses a directory service, such as Active Directory® from Microsoft Corporation. Another suitable business data source is an enterprise (non-public) social network service, such as SharePoint® My Site from Microsoft Corporation. In another example, the business data source 206 is a relational database. In yet another example, the business data source 206 is a file system.

In various embodiments, the client application 112 collects data from the data sources 206 in various ways. For example, the client application 112 can collect data from one or more of the data sources 206 by sending queries to the data sources 206. In another example, the client application 112 can collect data from one or more of the data sources 206 by sending Lightweight Directory Access Protocol (LDAP) messages to the data sources 206. In yet another example, the client application 112 can collect data from one or more of the data sources 206 by sending Hypertext Transfer Protocol (HTTP) messages to the data sources 206.

In various embodiments, various computing devices can provide the data sources 206. For example, one or more server devices operated by the organization 106 can provide one or more of the data sources 206. In another example, server devices operated by one or more organizations other than the organization 106 can provide one or more of the data sources 206. For instance, a cloud services provider or a third-party web service can provide one or more of the data sources 206. In yet another example, the client device 108 can provide one or more of the data sources 206. For example, one of the data sources 206 can comprise a global positioning system (GPS) built into the client device 108.

In various embodiments, the data sources 206 provide various types of data. For example, one or more of the data sources 206 can be a directory that stores information regarding people who work for the organization 106. In this example, the information can specify data such as job titles of the employees, the departments of the employees, project teams on which the employees have participated, committees on which the employees have served, email addresses of the employees, and other information about the employees of the organization 106. In this example, the user 102 and other people in the user's social network can be among the people who work for the organization 106. In another example, one or more of the data sources 206 can be a personal address book of the user 102. In yet another example, one of the data sources 206 can be a social networking service other than the social networking service 104. In this example, if the social networking service 104 is Facebook®, one of the data sources 206 might be LinkedIn®.

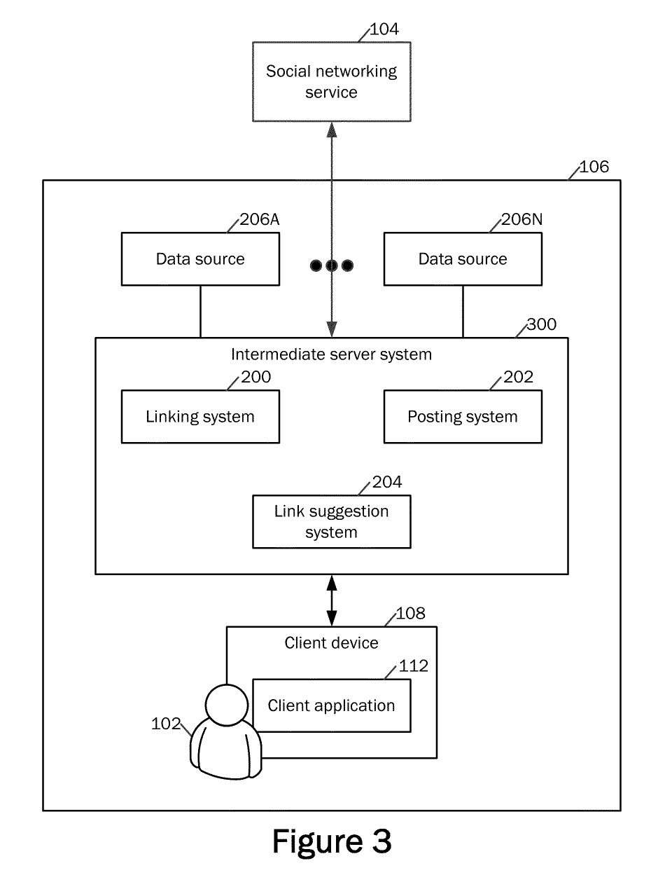

FIG. 3 is a block diagram illustrating example alternate details of the system 100. As illustrated in the example of FIG. 3, the organization 106 comprises an intermediate server system 300. The intermediate server system 300 comprises one or more computing devices. The intermediate server system 300 provides the linking system 200, the posting system 202, and the link suggestion system 204.

Various embodiments of the intermediate server system 300 provide the linking system 200, the posting system 202, and the link suggestion system 204 in various ways. For example, the intermediate server system 300 can comprise one or more processing units. In this example, the one or more processing units of the intermediate server system 300 read computer-executable instructions from one or more computer readable media and execute the computer-executable instructions. Execution of the computer-executable instructions by the processing units causes the intermediate server system 300 to provide the linking system 200, the posting system 202, and the link suggestion system 204.

In the example of FIG. 3, the client application 112 uses the linking system 200, the posting system 202, and the link suggestion system 204 by exchanging messages with the intermediate server system 300. In various embodiments, the messages can conform to various communication protocols. For example, the messages can conform to the Hypertext Transfer Protocol (HTTP), SOAP, or another communication protocol.

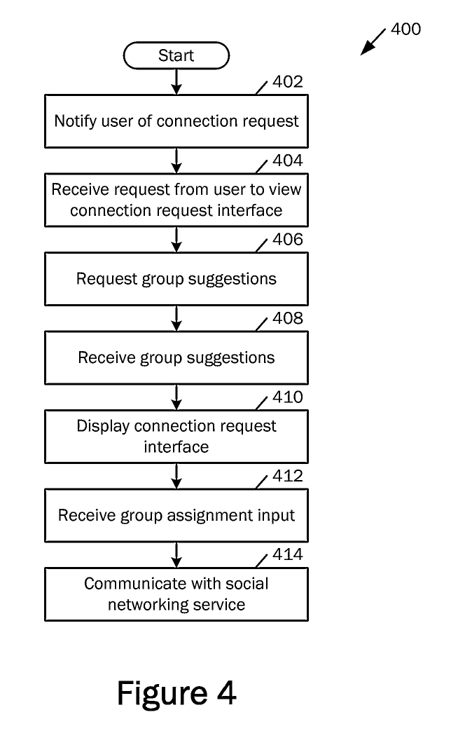

FIG. 4 is a flowchart illustrating an example operation 400 performed by the client application 112 when the user 102 receives a connection request from another user of the social networking service 104. After the operation 400 starts, the client application 112 notifies the user 102 of the connection request (402). Various embodiments of the client application 112 notify the user 102 of the connection request in various ways. For example, the client application 112 can display a connection request element on a user interface. In this example, the connection request element indicates that the user 102 has received a connection request. In another example, the client application 112 can notify the user 102 of the connection request by causing the client device 108 to output a given sound.

Subsequently, the client application 112 receives a request from the user 102 to view a connection request interface (404). Various embodiments of the client application 112 receive the request to view the connection request interface in various ways. For example, the client application 112 can receive the request to view the connection request interface when the user 102 clicks on or otherwise selects a connection request element displayed on a user interface presented by the client application 112. In another example, the client application 112 can receive the request to view the connection request interface when the user 102 selects a control displayed in a user interface presented by the client application 112.

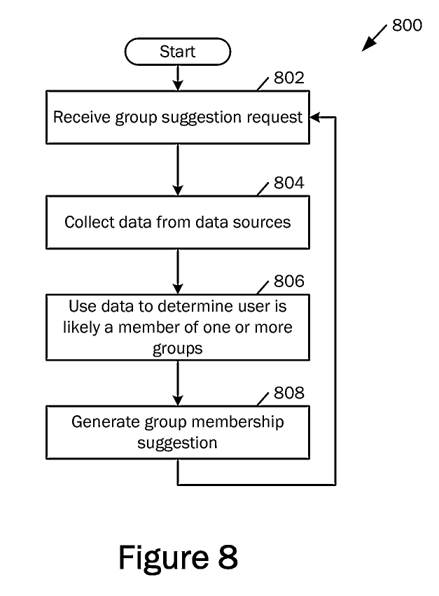

In response to receiving the request to view the connection request interface, the client application 112 provides a group suggestion request to the linking system 200 (406). The group suggestion request comprises a request for suggestions regarding groups to which the other user may belong. Subsequently, the client application 112 receives group membership suggestions from the linking system 200 (408). The group membership suggestions indicate groups to which the other user may belong. In various embodiments, the linking system 200 generates the group membership suggestions in various ways. FIG. 8, described in detail below, illustrates one example way that the linking system 200 can generate the group membership suggestions.

After the client application 112 receives the group membership suggestions, the client application 112 displays the connection request interface to the user 102 (410). The connection request interface includes information that indicates that the other user wants to add the user 102 to a social network of the other user. For example, the connection request interface can include information that indicates that a user named Steven Smith wants to add the user 102 to Steven Smith's social network. In addition, the connection request interface can include the group membership suggestions. For example, the connection request interface can include data indicating the Steven Smith may belong to a “materials engineering team” group and an “executives” group. Furthermore, the connection request interface includes features that enable the user 102 to assign the other user to one or more groups. In some instances, the connection request interface includes features that enable the user 102 to create one or more new groups and assign the other user to the one or more new groups.

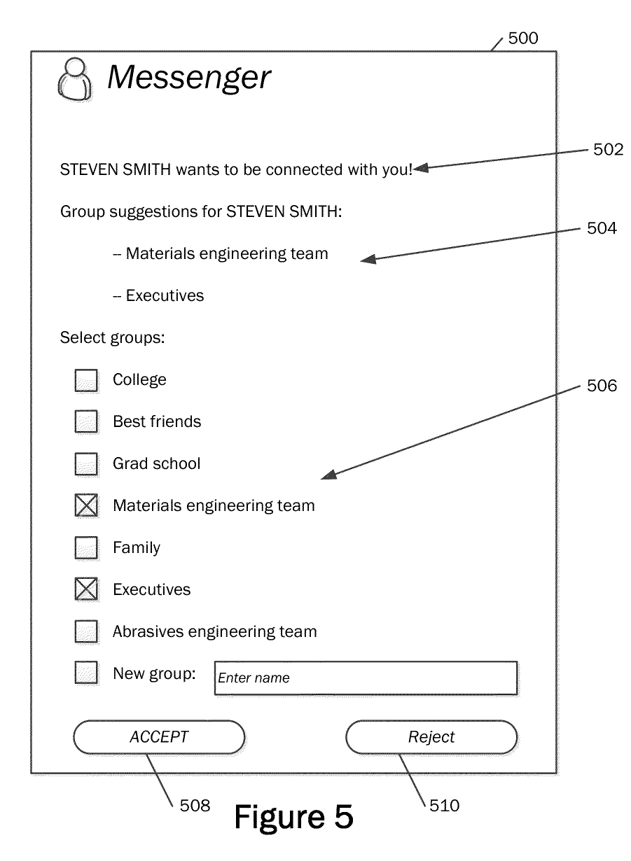

In various embodiments, the connection request interface has various appearances. FIG. 5 is a screen illustration showing an example connection request interface 500. The connection request interface 500 comprises a summary area 502, a group suggestion area 504, group selection controls 506, an accept control 508, and a reject control 510. The summary area 502 explains the purpose of the connection request interface 500. In the example of FIG. 5, the summary area 502 indicates that a user named “STEVEN SMITH” wants to be connected with the user 102.

The group suggestion area 504 indicates groups suggested by the linking system 200. In the example of FIG. 5, the group suggestion area 504 indicates that “STEVEN SMITH” may be a member of a “Materials engineering team” group and an “Executives” group.

The group selection controls 506 correspond to different ones of the user's groups. In the example of FIG. 5, each of the group selection controls 506 is a check box. By default, the group selection controls 506 corresponding to the suggested groups are checked. Hence, in the example of FIG. 5, the group selection controls 506 corresponding to the “Materials engineering team” group and the “Executives” group are checked.

The user 102 provides group selection input by checking or unchecking the group selection controls 506 and selecting the accept control 508. The user 102 can reject the request to connect with “STEVEN SMITH” by selecting the reject control 510.

Continuing reference is now made to the example of FIG. 4. During a time that the client application 112 displays the connection request interface to the user 102, the client application 112 receives group assignment input from the user 102 (412). The group assignment input indicates groups to which the user 102 wants to assign the other user. In some instances, the groups selected by the user 102 are the same as the groups suggested by the linking system 200. In other instances, the groups selected by the user 102 are different than the groups suggested by the linking system 200.

After receiving the group assignment input, the client application 112 communicates with the social networking service 104 to accept the connection request and to instruct the social networking service 104 to add the other user to the groups indicated by the group assignment input (414). Various embodiments of the client application 112 communicate with the social networking service 104 in various ways. For example, some embodiments of the client application 112 communicate with the social networking service 104 using a communication protocol such as HTTP. In another example, some embodiments of the client application 112 communicate with the social networking service 104 using a protocol, such as SOAP, to remotely invoke methods of an application programming interface (API) provided by the social networking service 104.

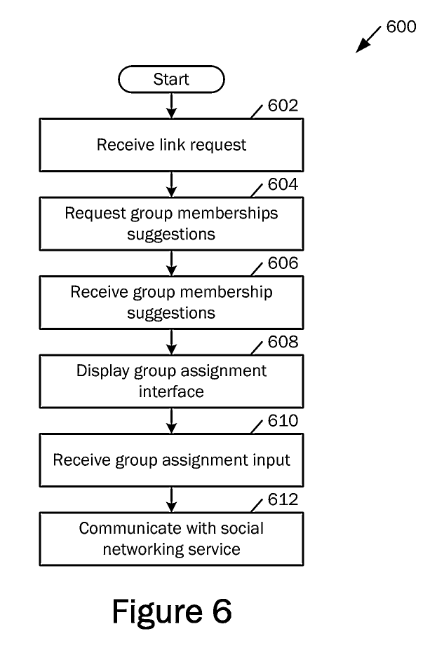

FIG. 6 is a flowchart illustrating an example operation 600 performed by the client application 112 when the user 102 adds another user to the user's social network. After the operation 600 starts, the client application 112 receives a link request from the user 102 (602). The link request comprises a request to add another user to the user's social network. In various embodiments, the client application 112 can receive the link request in various ways. For example, the client application 112 can present a profile page of the other user. In this example, the client application 112 can receive the link request when the user 102 selects a particular feature in the other user's profile page.

In response to receiving the link request, the client application 112 provides a group suggestion request to the linking system 200 (604). The group suggestion request comprises a request for suggestions regarding groups to which the other user may belong. Subsequently, the client application 112 receives group membership suggestions from the linking system 200 (606). The group membership suggestions indicate groups to which the other user may belong.

After the client application 112 receives the group membership suggestions, the client application 112 displays a group assignment interface to the user 102 (608). The group assignment interface includes information that indicates groups to which the other user may belong. For example, the group assignment interface can indicate that the other user may belong to a “co-workers” group. Furthermore, the group assignment interface includes features that enable the user 102 to assign the other user to one or more groups.

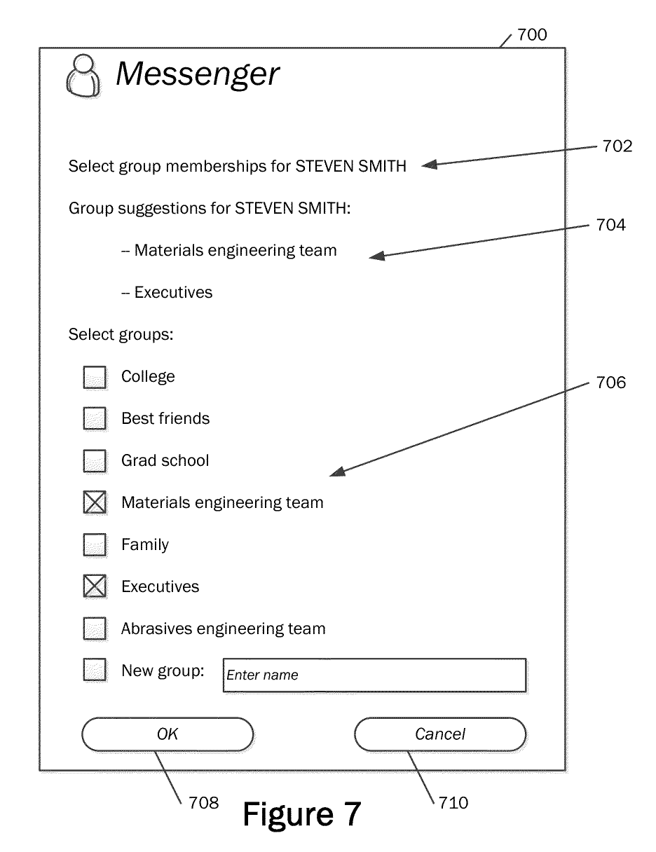

In various embodiments, the group assignment interface has various features and appearances. FIG. 7 is a screen illustrating showing an example group assignment interface 700. The group assignment interface 700 comprises a summary area 702, a group suggestion area 704, group selection controls 706, an ok control 708, and a cancel control 710. The summary area 702 explains the purpose of the group assignment interface 700. In the example of FIG. 7, the summary area 702 invites the user 102 to select group memberships for a user named “STEVEN SMITH.”

The group suggestion area 704 indicates groups suggested by the linking system 200. In the example of FIG. 7, the group suggestion area 704 indicates that “STEVEN SMITH” may be a member of a “Materials engineering team” group and an “Executives” group.

The group selection controls 706 correspond to different ones of the user's groups. In the example of FIG. 7, each of the group selection controls 706 is a check box. By default, the group selection controls 706 corresponding to the suggested groups are checked. Hence, in the example of FIG. 7, the group selection controls 706 corresponding to the “Materials engineering team” group and the “Executives” group are checked.

The user 102 provides group assignment input by checking or unchecking the group selection controls 706 and selecting the ok control 708. The user 102 can cancel the request to connect with “STEVEN SMITH” by selecting the cancel control 710.

Continuing reference is now made to the example of FIG. 6. During a time that the client application 112 displays the group assignment interface to the user 102, the client application 112 receives group assignment input from the user 102 (610). The group assignment input indicates groups to which the user 102 wants to assign the other user. For example, the group assignment input can indicate that the user 102 want to assign the other user to a “friends” group and a “family” group. After receiving the group assignment input, the client application 112 communicates with the social networking service 104 to instruct the social networking service 104 to invite the other user to join the user's social network and, if the other user accepts the invitation, add the other user to the groups indicated by the group assignment input (612).

FIG. 8 is a flowchart illustrating an example operation 800 of the linking system 200. After the operation 800 starts, the linking system 200 receives a group suggestion request from the client application 112 (802). The group suggestion request comprises a request for group membership suggestions for a given user.

In various embodiments, the linking system 200 can receive the group suggestion request when various events occur. For example, some embodiments of the linking system 200 can receive the group suggestion request when the user 102 is sending a connection request to another user of the social networking service 104. In another example, some embodiments of the linking system 200 can receive the group suggestion request when the user 102 receives a connection request from another user of the social networking service 104. In yet another example, the linking system 200 can receive the group suggestion request when the client application 112 receives new or updated data from the data sources 206 regarding the user 102 or another user in the social network of the user 102. In yet another example, some embodiments of the client application 112 generate group suggestion requests when a timer expires.

After receiving the group suggestion request, the linking system 200 collects data from one or more of the data sources 206 (804). The linking system 200 uses the collected data to determine that the given user is likely a member of one or more groups (806). For example, the linking system 200 can use the collected data to determine that the given user is likely a member of an “IT department” group.

Various embodiments of the linking system 200 collect various types of data from the data sources 206. For example, the linking system 200 can collect data from the data sources 206 indicating an organizational chart of the organization 106 and data from the data sources 206 indicating the job titles of the user 102 and the given user. In this example, the linking system 200 can determined, based on the organizational chart and/or the job titles, that the given user has a more senior position within the organization 106 than the user 102. Accordingly, the linking system 200 can, in this example, determine that the given user likely belongs to a group that corresponds to employees of the organization 106 having more senior positions in the organization 106 than the user 102.

Various embodiments of the linking system 200 use various algorithms to determine whether the given user is likely a member of one or more groups. For example, the linking system 200 can be configured with multiple rule sets. Each of the rule sets is associated with a different group. In this example, each of the rules specifies a condition and a point value. If the given user satisfies the condition of a rule in a rule set associated with a given group, the linking system 200 adds the rule's point value to a point total for the given group. If the point total for the given group exceeds a particular threshold, the linking system 200 determines that it is likely that the given user is a member of the given group. Various people can configure the linking system 200 to use the rule sets. For example, the user 102 can configure the linking system 200 to use the rule sets. In another example, an administrator associated with the organization 106 or another person can configure the linking system 200 to use the rule sets. Hence, in this example, the organization 106 may have some control over how the users are assigned to groups.

In some embodiments, the linking system 200 can determine that the given user likely belongs to a group that is not among the user's currently existing groups. For example, the user's groups might not include a group corresponding to people who have more senior positions in the organization 106 than the user 102. In this example, the linking system 200 may determine that the given user has a more senior position in the organization 106 than the user 102. Hence, in this example, the linking system 200 can suggest the creation of a new group for people having more senior positions in the organization 106 than the user 102.

The linking system 200 then generates one or more group membership suggestions (808). The group membership suggestions indicate one or more group to which the given user is likely to belong. Various embodiments of the linking system 200 generate the group membership suggestions in various ways.

For example, in some embodiments where the intermediate server system 300 provides the linking system 200, the linking system 200 can generate the group membership suggestions as data having a format interpretable by the client application 112. For instance, in this example, the linking system 200 can generate the group membership suggestions as Extensible Markup Language (XML) data, Hypertext Markup Language (HTML) data, or data having another format. In this example, the client application 112 interprets the group membership suggestions to present the suggested group memberships to the user 102.

In another example, in some embodiments where the client application 112 provides the linking system 200, the linking system 200 provides the group membership suggestions to the client application 112 as data structures returned by a function.

The linking system 200 can perform the operation 800 multiple times in response to multiple group suggestion requests. Thus, the linking system 200 can perform the operation 800 each time the user 102 sends or receives connection requests, or in response to changes to data regarding the users in the social network of the user 102.

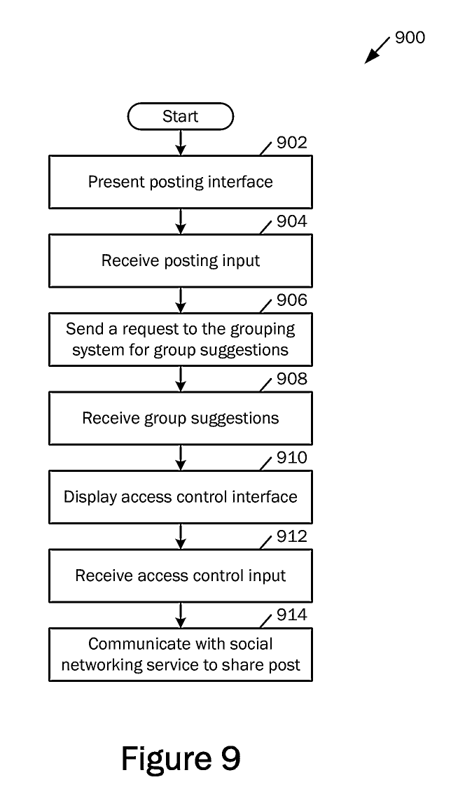

FIG. 9 is a flowchart illustrating an example operation 900 performed by the client application 112 to share a post on the social networking service 104. After the operation 900 starts, the client application 112 presents a posting interface to the user 102 (902). The posting interface includes features that enable the user 102 to input a post to be shared on the social networking service 104. For example, the posting interface can include one or more textboxes into which the user 102 can type a post. In some instances, the posting interface is a webpage or a portion of a webpage.

During a time that the client application 112 is presenting the posting interface, the client application 112 receives posting input from the user 102 (904). The posting input may be a posting request indicating that the user 102 wants to share a post on the social networking service 104. For example, the posting request can indicate that the user 102 wants to share the following post on the social networking service 104: “I'm at the bowling alley with Jen and Steve!”

When the client application 112 receives the posting input, the client application 112 sends an access suggestion request to the posting system 202 (906). The access suggestion request instructs the posting system 202 to identify groups that include members with whom it might be inappropriate to share the post. Subsequently, the client application 112 receives an access suggestion response from the posting system 202 (908). The access suggestion response indicates groups identified by the posting system 202 as including members of the user's social network with whom it may be inappropriate to share the post. For example, the access suggestion response can indicate that it may be inappropriate for the user 102 to share the post with members of an “executives” group.

After receiving the group suggestion response, the client application 112 displays an access control interface to the user 102 (910). The access control interface prompts the user 102 to designate which groups are allowed to access the post. Furthermore, the access control interface indicates to the user 102 that there is a possibility that the post is not appropriate for the user 102 to share with members of the groups indicated by the access suggestion response. In various embodiments, the access control interface can have various appearances and include various features. For example, in some embodiments, the access control interface comprise features that allows the user 102 to add groups to a list of groups whose members are allowed to access the post.

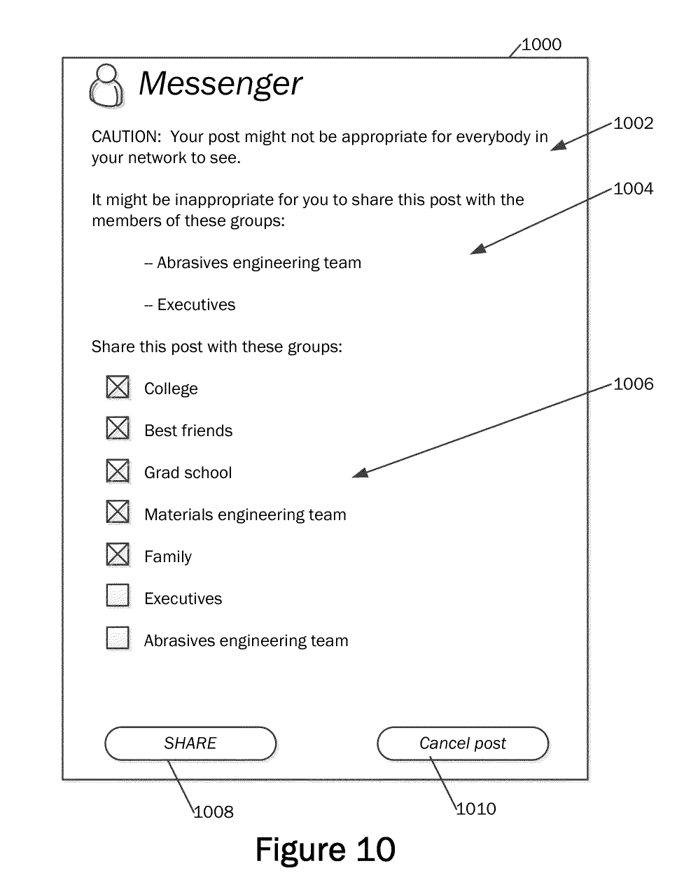

In various embodiments, the access control interface has various appearances and features. FIG. 10 is a screen illustration of an example access control interface 1000. The access control interface 1000 comprises an introduction area 1002, an inappropriate groups area 1004, group selection controls 1006, a share control 1008, and a cancel control 1010. The introduction area 1002 explains a purpose of the access control interface 1000. In the example of FIG. 10, the introduction area 1002 explains that the post might not be appropriate for everyone in the social network of the user 102 to see. The inappropriate groups area 1004 lists groups that the posting system 202 has identified as possibly including members with whom it might be inappropriate to share the post. In the example of FIG. 10, the inappropriate groups area 1004 indicates that it may be inappropriate to share the post with members of the “Abrasives engineering team” group and members of the “Executives” group.

Each of the group selection controls 1006 comprises a checkbox corresponding to a different one of the user's groups. By default, the group selection controls 1006 corresponding to the inappropriate groups identified by posting system 202 are not checked. The user 102 provides group selection input by checking and unchecking the group selection controls 1006 and by selecting the share control 1008. If the user 102 decides not to share the post at all, the user 102 selects the cancel control 1010.

Continuing reference is now made again to the example of FIG. 9. During a time that the client application 112 displays the access control interface, the client application 112 receives access control input from the user 102 via the access control interface (912). The access control input specifies groups designated by the user 102 as being allowed to access the post. For example, the access control input can specify that members of the “Friends” and “Family” groups are allowed to access the post, but that members of the “co-workers” group are not allowed to access the post. Some embodiments of the client application 112 prevent the user 102 from sharing the post on the social networking service 104 with members of the groups identified as possibly being inappropriate by the posting system 202.

After receiving the access control input, the client application 112 communicates with the social networking service 104 to instruct the social networking service 104 to share the post with members of the designated groups, but not with users of the social networking service 104 who are not members of the designated groups (914). For example, the client application 112 can communicate with the social networking service 104 to instruct the social networking service 104 to share the post with members of the “Friends” group and the “Family” group, but not members of the “co-workers” group.

Various embodiments of the posting system 202 communicate with the social networking service 104 in various ways. For example, some embodiments of the posting system 202 communicate with the social networking service 104 using a communication protocol such as HTTP. In another example, some embodiments of the posting system 202 communicate with the social networking service 104 using a protocol, such as SOAP, to remotely invoke methods of an application programming interface (API) provided by the social networking service 104.

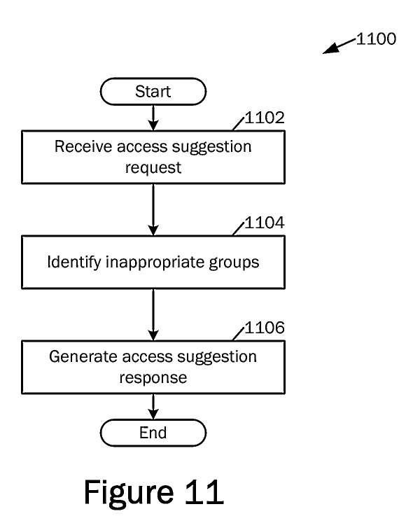

FIG. 11 is a flowchart illustrating an example operation 1100 performed by the posting system 202. After the operation 1100 starts, the posting system 202 receives an access suggestion request (1102). Various embodiments of the posting system 202 receive the access suggestion request in various ways. For example, in embodiments where the posting system 202 runs on the intermediate server system 300, the posting system 202 can receive the access suggestion request as a message that conforms to a communication protocol, such as HTTP. In another example, in embodiments where the posting system 202 runs on the client device 108, the posting system 202 can receive the access suggestion request when the client application 112 invokes a function or method of the posting system 202.

In response to receiving the request, the posting system 202 identifies inappropriate groups from among the user's groups (1104). It may be inappropriate for the user 102 to share the post with members of the inappropriate groups. For example, the posting system 202 can identify the “executives” group as including members with whom it may be inappropriate for the user 102 to share the post. In some instances, the posting system 202 identifies none of the user's groups as being inappropriate groups.

Various embodiments of the posting system 202 identify the inappropriate groups in various ways. For example, the organization 106 may implement rules that provide that posts containing certain keywords can only be shared with members of certain groups. In this example, the posting system 202 can analyze the content of the post to determine whether the post contains the keywords. For instance, in this example, the organization 106 can be developing a secret product codenamed “Project Titan.” In this instance, the organization 106 can implement a rule that provides that posts mentioning “Project Titan” can only be shared with members of the “Project Titan” group. In another example, the organization 106 may implement a rule providing that posts containing curse words or racial slurs cannot be shared with members of any group. In this example, the user 102, an administrator of the organization 106 or another user can select the keywords.

In yet another example, the post may contain a link to a given resource, such as a webpage or a video. In this example, the posting system 202 determines that the post contains the link. After determining that the post contains the link, the posting system 202 determines whether there is a possibility that given resource contains content that is not appropriate for the user 102 to share with members of a given group. For example, if the given resource is a video having violent content, the posting system 202 may determine that there is a possibility that it may be inappropriate for the user 102 to share the post groups having members that belong to the organization 106.

In some embodiments, the posting system 202 uses data from one or more of the data sources 206 to identify the inappropriate groups. For example, one of the data sources 206 provides information indicating a physical location of the client device 108. In this example, the posting system 202 can determine, based at least in part on the location of the client device 108, that there is a possibility that it is not appropriate for the user 102 to share the post with members of the inappropriate groups. For instance, if the client device 108 is located in a tavern, the posting system 202 can determine that the inappropriate groups include any of the user's groups that are related to the work of the user 102. In this instance, the posting system 202 does not need to store the location information or transmit the location information to any other party.

After identifying the inappropriate groups, the posting system 202 generates an access suggestion response (1106). In various embodiments, the access suggestion response indicates various things. For example, the access suggestion response can indicate the inappropriate groups. In another example, the access suggestion response can indicate ones of the user's groups other than the inappropriate groups. In other words, the access suggestion response can indicate groups with whom it may be appropriate to share the post.

Various embodiments of the posting system 202 generate the access suggestion response in various ways. For example, in some embodiments, the intermediate server system 300 provides the posting system 202. In this example, the posting system 202 can generate the access suggestion response by sending to the client application 112 data having a format readable by the client application 112. In another example, in some embodiments, the client device 108 provides the posting system 202. In this example, the posting system 202 can generate the access suggestion response by returning one or more data structures to the client application 112.

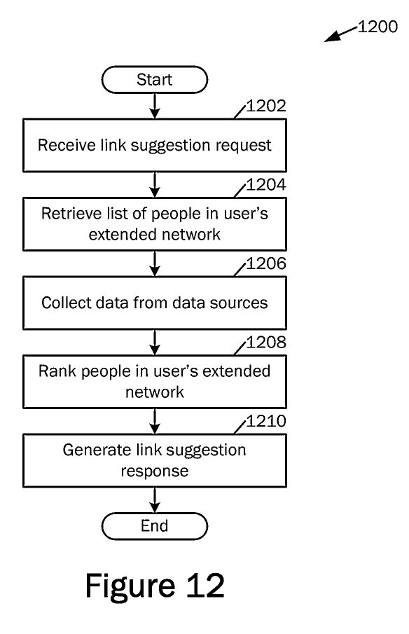

FIG. 12 is a flowchart illustrating an example operation 1200 of the link suggestion system 204. After the operation 1200 starts, the link suggestion system 204 receives a link suggestion request from the client application 112 (1202). The link suggestion request is a request for a ranked list of users of the social networking service 104 who the user 102 may know in real life, but who are not directly linked to the user 102 in the social networking service 104.

In various embodiments, the client application 112 sends the link suggestion request to the link suggestion system 204 in response to various events. For example, the client application 112 can send the link suggestion request to the link suggestion system 204 in response to the client application 112 receiving a request to display a webpage that includes suggested members of the user's social network.

After receiving the link suggestion request, the link suggestion system 204 communicates with the social networking service 104 to retrieve a list of at least some of the people in the user's extended network (1204). The people in the user's extended network are users of the social networking service 104 who are not directly linked to the user 102, but who are indirectly linked to the user 102 through one or more people. For example, a user “Jane Smith” may be linked to “John Simon,” but not to the user 102. In this example, “John Simon” may be a member of the user's social network. Hence, in this example, “Jane Smith” is a member of the user's extended network. In this example, a user “Joan Mason” may be linked to “Jane Smith,” but not the user 102 or “John Simon.” In this example, the user “Joan Mason” is also a member of the user's extended network.

Various embodiments of the link suggestion system 204 limit the user's extended network to a given number of links. For example, some embodiments of the link suggestion system 204 only retrieve information regarding users who are separated from the user 102 by one person. In another example, some embodiments of the link suggestion system 204 only retrieve information regarding users who are separated from the user 102 by one or two people.

After retrieving the list of people in the user's extended network, the link suggestion system 204 collects data from one or more of the data sources 206 (1206). The link suggestion system 204 then uses the collected data to generate a ranking of people in the user's extended network (1208). In other words, the link suggestion system 204 generates the ranking based at least in part on the collected data. The ranking can reflect the probabilities that the user 102 knows the people in the user's extended network in real life.

In various embodiments, the link suggestion system 204 collects various types of data from the data sources 206 and uses the collected data in various ways. For example, a first user and a second user can belong to the user's extended network. In this example, the link suggestion system 204 can collect data that represents an organizational chart of the organization 106. In this example, the link suggestion system 204 can use the organizational chart to determine that the user 102 and the first user work in the same department. In this example, the link suggestion system 204 can use the organizational chart to determine that the user 102 and a second user both work for the organization 106, but in different departments. Hence, it may be more likely that the user 102 knows the first user than the second user. Accordingly, in this example, the link suggestion system 204 can rank the first user higher than the second user.

In another example, a first user and a second user can belong to the user's extended network. In this example, the link suggestion system 204 can collect data indicating that the first user works in a given office. In this example, the link suggestion system 204 can collect data indicating that the second user works in a remote office. If the user 102 works in the given office and not the remote office, the link suggestion system 204 can rank the first user higher than the second user.

After ranking people in the user's extended network, the link suggestion system 204 generates a link suggestion response (1210). The link suggestion response comprises data that indicate the ranks of people in the user's extended network. Some embodiments of the client application 112 use the link suggestion response to present a link suggestion interface. The link suggestion interface contains a listing of at least some of the people in the user's extended network. In the link suggestion interface, the people in the user's extended network are ordered based on the rankings generated by the link suggestion system 204.

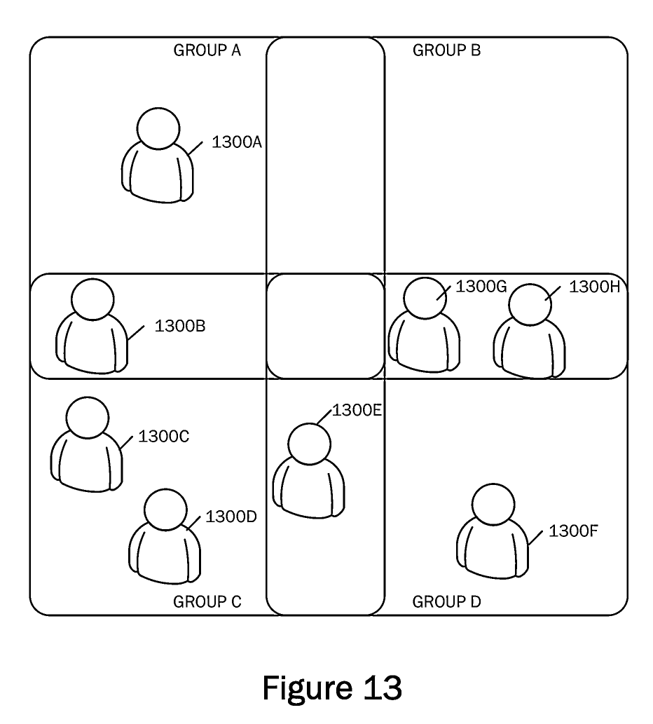

FIG. 13 is a diagram illustrating an example grouping of the users in the social network of the user 102. In the example of FIG. 13, the user 102 has created four groups: Group A, Group B, Group C, and Group D.

The social network of the user 102 includes users 1300A-H (collectively, “users 1300”). The user 1300A and the user 1300B belong to Group A. The users 1300G and 1300H belong to Group B. The users 1300B, 1300C, 1300D, and 1300E belong to Group C. The users 1300E, 1300F, 1300G, and 1300H belong to Group D.

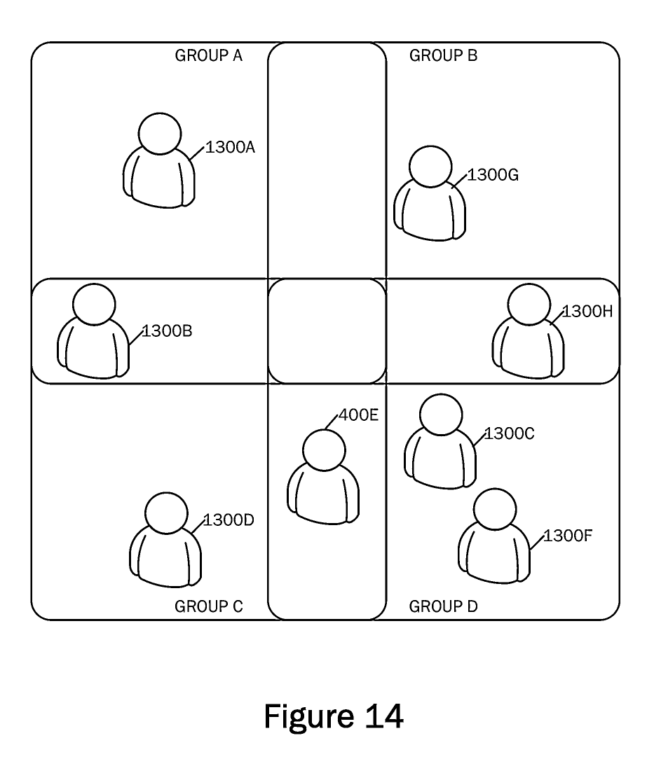

FIG. 14 is a diagram illustrating another example grouping of the users 1300 in the social network of the user 102. The grouping in FIG. 14 differs from the grouping in FIG. 13 in that the user 1300C has left Group C and entered Group D. In addition, the grouping in FIG. 14 differs from the grouping in FIG. 13 in that the user 1300G has left Group D but remained in Group B.

After the user 102 assigns a given user to a given group, circumstances might change and the given user should belong to another group. For example, Groups B and C can correspond to different departments of the organization 106. In this example, the user 1300C may move from one of the departments to another one of the departments. Accordingly, the user 1300C should move from Group C to Group D. In another example, Group B can correspond to a particular project team and Group D can correspond to peers of the user 102. In this example, the user 1300G can stay with the project team, but be promoted to supervisor for the project team. Hence, the user 1300G should move out of Group D, but stay in Group B.

In yet another example, the Group B can correspond to a particular project team and Group D can correspond to peers of the user 102. In this example, the user 102 may be promoted to supervisor for the project team. As a result, the user 1300G is no longer a peer of the user 102 in a hierarchy of the organization 106. Hence, the user 1300G should move out of Group D (i.e., the “peers” group).

Some embodiments of the linking system 200 use the data from one or more of the data sources 206 to suggest updated group memberships for the users 1300. For example, the linking system 200 can determine, based at least in part on the data from the one or more data sources 206, that a given user is no longer a member of a given group. In this example, the client application 112 can provide a group non-membership suggestion to the user 102. The group non-membership suggestion indicates that the given user likely is no longer a member of the given group. In alternative embodiments, the group memberships of the social networking service 104 are automatically updated, and the given user is notified that changes have been made.

For instance, one of the data sources 206 is a directory that stores information about employees of the organization 106. In this example, the organization 106 can update an entry in the directory to indicate that the user 1300G has been promoted to supervisor of a project team. Because the user 1300G is now a supervisor, it may now be inappropriate for the user 102 to share certain posts with the user 1300G. However, in this example, updating the directory does not update the group to which the user 1300G belongs on the social networking service 104. In other words, the social networking service 104 does not “know” that the user 1300G was promoted and therefore should belong to a different group. In this example, the linking system 200 may suggest to the user 102 that the user 1300G should belong to a “supervisors” group and provide a non-membership suggestion that indicates that the user 1300 is no longer a member of a “peers” group.

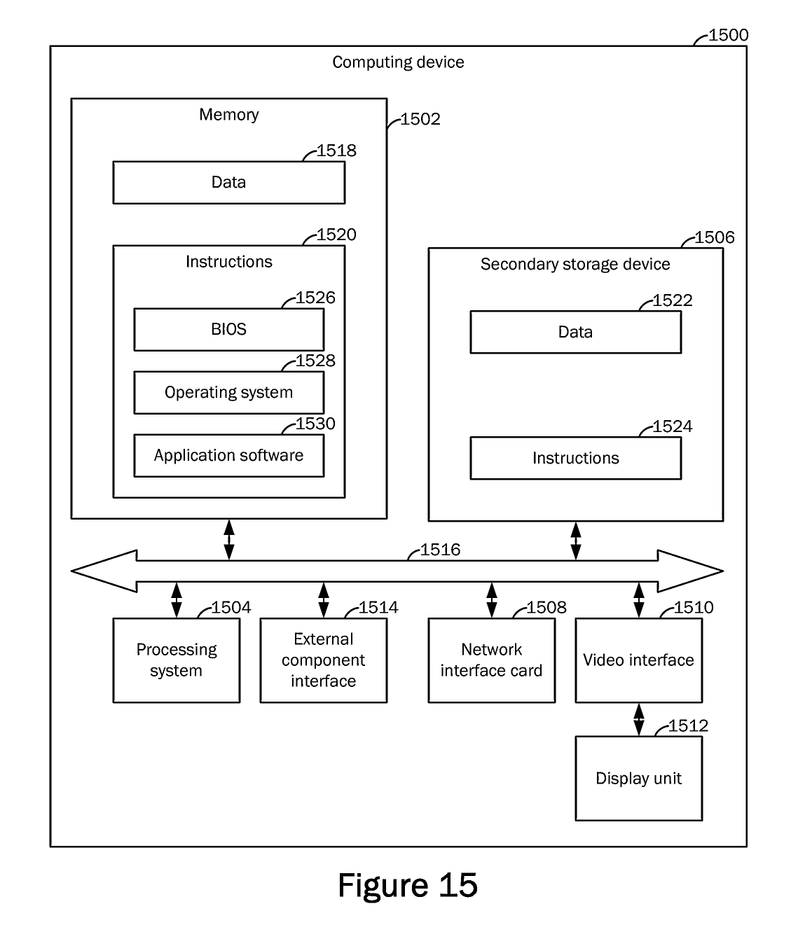

FIG. 15 is a block diagram illustrating example physical components of a computing device 1500. The client device 108, the social networking service 104, the intermediate server system 300, and other computing devices in the system 100 can have components similar to those of the computing device 1500. It should be appreciated that these computing devices can be implemented using computing devices having components other than those illustrated in the example of FIG. 15.

As used herein, the term computer readable media may include computer storage media and communication media. A computer storage medium is a device or article of manufacture that stores data and/or computer-executable instructions. A computer storage medium does not consist of transitory signals. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

Communication media may include any information delivery media that carries computer-executable instructions, data structures, program modules, or other data in a modulated data signal. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the example of FIG. 15, the computing device 1500 comprises a memory 1502, a processing system 1504, a secondary storage device 1506, a network interface card 1508, a video interface 1510, the display unit 1512, an external component interface 1514, and a communications medium 1516. The memory 1502 includes one or more computer storage media capable of storing data 1518 and/or computer-executable instructions 1520.

The secondary storage device 1506 includes one or more computer storage media. The secondary storage device 1506 stores data 1522 and computer-executable instructions 1524 not directly accessible by the processing system 1504. In other words, the processing system 1504 performs an I/O operation to retrieve the data 1522 and/or the computer-executable instructions 1524 from the secondary storage device 1506.

The processing system 1504 includes one or more processing units. A processing unit is a physical device or article of manufacture comprising one or more integrated circuits that read data and instructions from computer readable media, such as the memory 1502 and the secondary storage device 1506, and selectively execute the instructions. In various embodiments, the processing system 1504 is implemented in various ways. For example, the processing system 1504 can be implemented as one or more processing cores. In another example, the processing system 1504 can comprise one or more separate microprocessors. In yet another example embodiment, the processing system 1504 can comprise an application-specific integrated circuit (ASIC) that provides specific functionality. In yet another example, the processing system 1504 provides specific functionality by using an ASIC and by executing computer-executable instructions.

The network interface card 1508 is a device or article of manufacture that enables the computing device 1500 to send data to and receive data from a communication network. In different embodiments, the network interface card 1508 is implemented in different ways. For example, the network interface card 1508 can be implemented as an Ethernet interface, a token-ring network interface, a fiber optic network interface, a wireless network interface (e.g., Wi-Fi, WiMax, etc.), or another type of network interface.

The video interface 1510 enables the computing device 1500 to output video information to the display unit 1512. The display unit 1512 can be various types of devices for displaying video information, such as a cathode-ray tube display, an LCD display panel, a plasma screen display panel, a touch-sensitive display panel, an LED screen, or a projector. The video interface 1510 can communicate with the display unit 1512 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1514 enables the computing device 1500 to communicate with external devices. For example, the external component interface 1514 can comprise a USB interface, a FireWire interface, a serial port interface, a parallel port interface, a PS/2 interface, and/or another type of interface that enables the computing device 1500 to communicate with external devices. In various embodiments, the external component interface 1514 enables the computing device 1500 to communicate with various external components, such as external storage devices, input devices, speakers, modems, media player docks, other computing devices, scanners, digital cameras, and fingerprint readers.

The communications medium 1516 facilitates communication among the hardware components of the computing device 1500. In the example of FIG. 15, the communications medium 1516 facilitates communication among the memory 1502, the processing system 1504, the secondary storage device 1506, the network interface card 1508, the video interface 1510, and the external component interface 1514. The communications medium 1516 can be implemented in various ways. For example, the communications medium 1516 can comprise a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1502 stores various types of data and/or software instructions. For example, the computer-executable instructions 1520 in the memory 1502 can include Basic Input/Output System (BIOS) instructions 1526 and operating system instructions 1528. Execution of the BIOS instructions 1526 by the processing system 1504 causes the computing device 1500 to boot up. Execution of the operating system instructions 1528 causes the computing device 1500 to provide an operating system that coordinates the activities and sharing of resources of the computing device 1500. Furthermore, the memory 1502 stores application software 1530. Execution of the application software 1530 by the processing system 1504 configures the computing device 1500 to provide one or more applications. The memory 1502 also stores data 1518 used by programs that execute on the computing device 1500.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders or be executed concurrently. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The claimed invention is:

1. A method of guiding interactions between users of a social networking service based on business relationships, the method comprising the steps of:
processing a connection between a first user and a second user of a social networking service via a computing device, the first user being associated with an organization;
collecting data from a business data source about the organization via a computing device as collected data, the business data source being separate from the social networking service;
determining a business relationship between the first user and the second user via the computing device based on the collected data; and
suggesting placement of the second user into a suggested privacy group within the social networking service based on the business relationship between the first user and the second user to the first user via the computing device.

2. The method of claim 1 further comprising the step of instructing the social networking service to add the second user to the privacy group.

3. The method of claim 1 wherein the step of collecting the data from the business data source comprises the step of collecting the data from a directory that stores information regarding people who work for an organization.

4. The method of claim 1, wherein the step of collecting the data from the business data sources comprises the step of collecting additional data from a second social networking service.

5. The method of claim 1 wherein the step of determining a business relationship between the first user and the second user within the organization further comprises the steps of:
calculating a privacy score via the computing device based on the collected data;
comparing the privacy score to a threshold group value via the computing device; and
determining the relationship between the first user and the second user within the organization based on the value of the privacy score relative to the threshold group value via the computing device.

6. The method of claim 5 further comprising the step of setting the threshold group value based on organizational requirements.

7. The method of claim 1 further comprising the step of establishing a set of business groups comprising recommended privacy groups for use with the social networking service based on organizational requirements and wherein the step of suggesting placement of the second user into a privacy group further comprises the step of selecting a business group from the set of business groups based on the business relationship as the suggested privacy group via the computing device.

8. The method of claim 7 wherein the suggested privacy group does not exist in the social networking service, the method further comprising the step of creating the suggested privacy group in the social networking service via the computing device.

9. The method of claim 1 wherein the collected data used in the step of determining a relationship between the first user and the second user within the organization is selected from data from the group consisting of organizational distance, level in organizational hierarchy, position in organizational hierarchy, placement in enterprise social networking groups, supervisory relationship, frequency of communication within the organization, history of communications between the first user and the second user, and organizational restrictions.

10. The method of claim 1, further comprising:
collecting extended association data from the business data source;
generating, based at least in part on the extended association data, a ranking of people in an extended network of the first user; and
displaying a link suggestion interface to the first user, the link suggestion interface listing at least one person in the extended network of the first user in an order based on the ranking.

11. The method of claim 1 further comprising the steps of:
checking the business relationship between the first user and a selected member of a first privacy group via the computing device based on the collected data;
where the selected member is determined to no longer be part of the first privacy group based on the business relationship between the first user and the selected member, suggesting removal of the selected member from the first privacy group to the first user via the computing device; and
where the selected member is determined to be part of a second privacy group based on the business relationship between the first user and the selected member, the second privacy group being different from the first privacy group, suggesting the selected member be added to the second privacy group to the first user via the computing device.

12. A method of guiding interactions between users of a social networking service based on business relationships, the method comprising the steps of:
processing a content sharing activity by a user of a social networking service via a computing device where the user intends to share selected content with members of a privacy group maintained by the user, the user being associated with an organization;
determining a business relationship between the user and the privacy group via the computing device based on data from a business data source about the organization via a computing device, the business data source being separate from the social networking service;
analyzing the selected content based on data from the business data source via a computing device to obtain a content analysis; and
guiding the content sharing activity based on the content analysis and the business relationship.

13. The method of claim 12 wherein the step of guiding the content sharing activity further comprises the step of suggesting whether the selected content is appropriate to share with the members of the privacy group based on the business relationship and the content analysis.

14. The method of claim 12 wherein the selected content is not appropriate to share with the members of the privacy group, the step of guiding the content sharing activity further comprises the step of preventing the selected content from being shared with the members of the privacy group.

15. The method of claim 12 wherein selected content contains textual material, the step of analyzing the selected content comprises the steps of:
providing a set of flagged text, the set of flagged text comprising selected words providing an indication of whether the textual content is appropriate to share with the social networking service privacy group; and
determining whether the textual material contains words from the set of flagged text.

16. The method of claim 15 wherein the step of providing a set of flagged text further comprises the step of populating the set of flagged text with words based on organizational requirements.

17. The method of claim 15, wherein the step of determining whether the textual material contains words from the set of flagged text further comprises the step of calculating an appropriateness score via the computing device based on the words from the set of flagged text present in the textual material; and
wherein the step of suggesting whether the selected content is appropriate to share further comprises the steps of:
comparing the appropriateness score to a threshold content value for the privacy group via the computing device; and
determining whether the selected content is appropriate to share to with the members of privacy group based on the value of the appropriateness score relative to the threshold content value via the computing device.

18. The method of claim 17 further comprising the step of setting the threshold content value based on organizational requirements.

19. The method of claim 12 further comprising the steps of:
collecting data indicating a location of a client device used by the user; and
wherein the step of analyzing the selected content further comprises the step of factoring the location data into the content analysis.

20. A computer-readable medium containing computer executable instruction which when executed by a computer perform a method of guiding interactions between users of a social networking service based on business relationships, comprising:
processing a connection between a first user and a second user of a social networking service, the first user being associated with an organization;
collecting data from a business data source about the organization via a computing device as collected data, the business data source being separate from the social networking service;
determining a business relationship between the first user and the second user via the computing device based on the collected data;
suggesting placement of the second user into a suggested privacy group within the social networking service based on the business relationship between the first user and the second user to the first user via the computing device;
processing a content sharing activity by the first user of the social networking service where the first user intends to share selected content with members of a privacy group maintained by the first user;
determining a business relationship between the first user and the privacy group via the computing device based on data from the business data source about the organization via the computing device, the business data source being separate from the social networking service;
analyzing the selected content based on data from the business data source to obtain a content analysis; and
guiding the content sharing activity based on the content analysis and the business relationship.
